(19) United States
(12) Patent Application Publication
(10) Pub. No.: US 2004/0220322 A1
(43) Pub. Date: Nov. 4, 2004

(54) Faux effects pigment compositions

(76) Inventors: Kim D. Gooding, Wilmington, DE (US); Yvette M. Swanson, Cleveland Heights, OH (US); Frances A. Amy, White Plains, NY (US); Christina Short, Cleveland, OH (US)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/772,813

(22) Filed: Feb. 5, 2004

Related U.S. Application Data
(60) Provisional application No. 60/448,279, filed on Feb. 18, 2003.

(51) Int. Cl. C08K 5/00; C08K 3/00; C09B 48/00; C09B 67/52

(52) U.S. Cl. 524/502; 106/499; 106/493; 106/494; 106/495; 106/496; 106/497; 524/503; 524/512; 524/543

(57) ABSTRACT

The present invention relates to paint compositions having a water-based resin system having a colorant granule that does not dissolve therein. The resulting paint compositions produce unusual, but desirable, effects after the application of sufficient pressure to release a second colorant. Hence, the present invention includes methods for their use and manufacture.

This application claims the benefit under 35 U.S.C. 119(e) of U.S. Provisional application No. 60/448,279, filed Feb. 18, 2003.

The invention relates to pigment compositions that contain a colorant granule that is substantially insoluble in water-based systems, a process for its production and use in coloring substrates to create desired architectural effects.

### BACKGROUND OF THE INVENTION

Various compositions containing pigment dispersions are known. EP-A-947,540 claims a dry master batch comprising at least one pigment, wherein the masterbatch contains at least 80% by weight calculated on the weight of the mixture of particles of granulometry of lower than 1 μm of said of least one pigment dispersed in said carrier. The process of EP-A-947,540 uses at least one turbo-mixer and solvents, which are disadvantageous in an industrial process. Further, the product contains fine powder, which has to be removed in order to obtain a satisfactory final product.

Pigment granules are known per se. For example, pigment preparations are commercially available from Ciba Specialty Chemicals Inc., as mixtures of 45 to 60% of an organic pigment, 2% of a dispersing agent (ethoxylated amine), 6.5 to 8.6% of polyethylene wax (LMWPE) and 46.5 to 29.4% of an urea-aldehyde resin. Previously, it has been thought essential for such pigment granules to be dispersible. Hence, it is unknown to use such granules in paint compositions in such a way as to create distinct and immiscible phases.

Faux effects pigments are also known, as shown in U.S. Pat. No. 5,536,769. The patent teaches that faux effects, such as creating the appearance of grains to replicate natural marble, granite, etc. can be achieved by utilizing a particular blend of colorants and liquid mixtures. The essential component is propylene glycol. The patent also emphasizes that oil-based dyes and pigments are not suitable.

The object of this invention is to provide new latex pigment compositions that create faux effects and/or textural effects when applied to a substrate.

### DETAILED DESCRIPTION OF THE INVENTION

The present invention relates to water-based paint systems that produce distinctive faux, textural, and/or surface effects after application and drying on a selected substrate. Specifically the paint or coating composition comprises a water-based paint or coating system having an aqueous phase containing colorant granules that do not dissolve in the aqueous phase. Once the coating is applied to a surface, shear or pressure can be applied to the coating, thus causing a color burst, or rupturing of the colorant granules causing the faux effect. There are several advantages of this invention. The faux effect can be achieved by applying one coating containing the colorant granules and obtaining an uneven color change or faux effect without carrying out the multiple steps of traditional faux paint techniques. Further, the color burst can be created when the paints are wet or dry giving the user more time to work with the system than traditional faux painting which requires the work be done only in the wet state.

Water-based paints are primarily latex paints, wherein the colorant granules are dispersed throughout the water phase. In latex paints, the latex binder consists of very small particles of liquid to semisolid polymer separated by water, which is the continuous phase. When the water evaporates, the polymer particles touch each other and fuse together, or coalesce, into a continuous paint film on drying. When used, pigment particles are also dispersed in the water phase, and the dry paint film consists of a mixture of pigment and polymer particles fused together.

Examples of latex paint compositions include those based on resins or binders of acrylonitrile, homopolymers of styrene, copolymers of acrylonitrile, homopolymers and copolymers of vinyl halide resins such as vinyl chloride, or vinyl esters such as vinyl acetate, vinyl acetate homopolymers and copolymers, homopolymers and copolymers of acrylic and methacrylic acid and their esters and derivatives, polybutadiene, butyl rubber, ethylene-propylene copolymers, olefinic resins like polyethylene and polypropylene, polyvinyl alcohol, epoxies, epoxy esters, carboxylated natural and synthetic lattices, polyurethane and similar resin-polymer latex systems.

Such paints and coatings are well known in the art, and typically comprise an emulsion and a dispersion or suspension of discrete dispersible particles of resin binder and pigment, including titanium dioxide, and other chemicals in water. Further optional ingredients often include clay, barium sulfate, talc, surfactants, coalescing agents, and the like. It should be noted that the instant invention could be suitable for use in clear coat systems wherein the system does not contain a dispersed pigment or colorant other than the colorant granules described hereinafter.

An essential attribute of this invention is the presence of a colorant granule that is incompatible with conventional latex-based colorants. Incompatible means that the colorant granule forms a distinct phase within the latex paint composition. The distinct phase is caused by completely covering a selected colorant with a polymeric material that does not readily dissolve in an aqueous or latex system and has sufficient durability to withstand mild stirring and mixing.

The term “granule” should be understood to mean a solid form of a grain, particle, microparticle, pellet, whether shredded or in a very fine dust. Colorants are pigments or dyes, as well as mixtures of pigments and/or dyes. Pigments may be organic and inorganic pigments, including effect pigments; their color may be due to selective or non-selective absorption, reflection and/or interference of light.

A particularly preferred colorant granule and a means for producing such a preferred colorant granule is described in copending application Ser. No. 10/163,918, which is incorporated herein by reference. The actual process for producing the colorant granule is not limited to this particular system and colorant granule products made by other means are commercially available.

The process described in the copending application provides that in step a) a pigment and a urea-aldehyde resin and/or urea-ketone resin are mixed. The mixing can be carried out in a separate homogenizer or in the inlet (feeding) zone of an extruder. If the mixing is carried out in the inlet zone of the extruder the pigment and the resin can be jointly introduced at the beginning of the inlet zone or the resin is added at first and the pigment is added subsequently. However, mixing of the components in a separate homogenizer is preferred. The homogenizer is not specially limited. In principal any device can be used, which provides proper mixing, i.e. a homogeneous distribution of the components, such as low-speed or high-speed mixers, tumblers or blenders. A tumbler is preferred.

If the mixing is carried out in a homogenizer, the pigment and the resin are generally mixed for 5 to 120 minutes, preferably 10 to 30 minutes, most preferably 15 minutes at a temperature ranging from 5 to the glass transition temperature of the resin, for example 50° C. in case of Laropal® A81, preferably 15 to 25° C.

The weight ratio of pigment to urea-aldehyde and/or urea-ketone resin is generally in the range of 40:60 to 90:10, preferably 50:50 to 80:20.

Urea-aldehyde resins and urea-ketone resins belong to the class of aminoplast resins and are curable condensation products of ureas and aldehydes, such as acetaldehyde, glyoxal and formaldehyde, in particular formaldehyde, or ketones. They are characterized by the following repeating unit

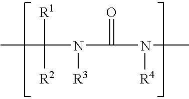

wherein R¹, R², R³ and R⁴ are independently of each other hydrogen or a organic group, such as linear or branched C₁-C₄-alkyl group. Urea-aldehyde resins, in particular urea-formaldehyde resins, are preferred. Relevant information on raw materials used to produce urea-formaldehyde resins can be found in B. Meyer: Urea-Formaldehyde Resins, Addison-Wesley, London 1979. Most preferred are LAROPAL® A81 (BASF AG, softening point: 80-95° C.) and A101 (BASF AG, softening point: 95-110° C.).

The paint or coating composition of the invention preferably uses a colorant granule which is a homogenous blend of a coloring agent and a urea-aldehyde resin and/or a urea-ketone resin.

In general any organic or inorganic pigment can be used to formulate the colorant granule, if it is compatible with urea-formaldehyde and the urea-ketone resins and is processable with the process according to the present application. Depending on the application, a crude or unfinished pigment can be used, but preferably the pigmentary form of the pigment is employed. The shape depends on the desired coloristic effect and may be for example isomorph, platelet- or flake-like, or even acicular. Granules, as described, for example, in U.S. Pat. No. 5,985,019, can also be processed according to the inventive process.

Suitable organic pigments are, for example, described in W. Herbst, K. Hunger, Industrial Organic Pigments, 2^{nd} revised edition, 1995. Especially suitable organic pigments for the present pigment compositions are organic pigments selected from the group consisting of azo, azomethine, methine, anthraquinone, phthalocyanine, perinone, perylene, naphthol, benzimidazoline, diketopyrrolopyrrole, thioindigo, iminoisoindoline, dioxazine, iminoisoindolinone, quinacridone, flavanthrone, indanthrone, anthrapyrimidine and quinophthalone pigments, or a mixture or solid solution thereof; especially an azo, dioxazine, diketopyrrolopyrrole, quinacridone, phthalocyanine, indanthrone , iminoisoindolinone pigment, and a mixture or solid solution thereof.

Notable organic pigments are those pigments described in the Color Index, including the group consisting of C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Yellow 191.1, C.I. Pigment Yellow 74, C.I. Pigment Yellow 83, C.I. Pigment Yellow 13, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, and C.I. Pigment Green 36, or a mixture or solid solution thereof.

Suitable inorganic pigments are selected from the group consisting of carbon black, metal oxides, mixed metal oxides, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, nickel titanate and bismuth vanadate, and mixtures thereof.

Alternatively, the colorant granule can be prepared as described above using dyes. Acceptable reactive dye classes include reactive, solution, and direct, for example, monochlorotriazine, monofluorotriazine, tetrachloropyrimidine, 2,3-dichloroquinoxaline, dichlorophthalazine, 5-chlorodifluoropyrimidinyl, β-sulfatoethylsulfamoyl, β-chloroethylsulfamoyl, sulfatoethylsulfone, and vinyl sulfone reactive dyes, although essentially any reactive dye could be used. Examples of reactive dyes useful in the present invention include, but are not limited to, Cl Reactive Yellow 7, Cl Reactive Yellow 18, Cl Reactive Yellow 22, Cl Reactive Yellow 55, Cl Reactive Yellow 86, Cl Reactive Orange 4, Cl Reactive Orange 12, Cl Reactive Orange 13, Cl Reactive Orange 35, Cl Reactive Orange 66, Cl Reactive Red 2, Cl Reactive Red 3, Cl Reactive Red 5, Cl Reactive Red 6, Cl Reactive Red 11, Cl Reactive Red 31, Cl Reactive Green 8, Cl Reactive Blue 4, Cl Reactive Blue 5, Cl Reactive Blue 9, Cl Reactive Blue 13, Cl Reactive Blue 49, Cl Reactive Blue 63, Cl Reactive Blue 71, Cl Reactive Blue 72, Cl Reactive Blue 62, Cl Reactive Blue 96, Cl Reactive Blue 99, Cl Reactive Blue 109, Cl Reactive Blue 122, Cl Reactive Blue 140, Cl Reactive Blue 161, Cl Reactive Blue 162, Cl Reactive Blue 163, Cl Reactive Blue 166, Cl Reactive Blue 198, Cl Reactive Violet 1, Cl Reactive Brown 9, Cl Reactive Brown 10, Cl Reactive Brown 17, Cl Reactive Brown 22, Cl Reactive Brown 23, Cl Reactive Black 8, and Cl Reactive Black 14. This list is meant to be exemplary and not exhaustive. Many of the dyes described above are commercially available from Ciba Specialty Chemicals.

The term “mixtures thereof” also comprises mixtures of inorganic and organic pigments as described, for example in U.S. Pat. No. 5,976,238, as well as mixtures of dyes or dyes and pigments.

The pigments used in the instant invention can have special properties such as a goniochromatic effect that displays an angle-dependent color change or pigments that exhibit metamerism as an effect. These pigments are commonly referred to as effect pigments. Especially strong goniochromatic effects are obtained with interference pigments, in particular such comprising semitransparent layers. Pigments that display a pearlescent or lustrous effects can also be used, including mica and metal flakes, optionally coated with thin dielectric layers. Dyes may be used in a dissolved, dispersed or liquid crystalline state. Optionally treated mica are especially suitable for conventional faux effects.

The coating formed using the faux effect of the invention can have varying gloss levels such as flat, satin, eggshell, semi-gloss and high-gloss finish.

Extrusion of the coloring agent and a urea-aldehyde resin and/or a urea-ketone resin to form the colorant granules can be carried out on co-rotating twin-screw extruders, in particular co-rotating closely intermeshing twin-screw extruders, and counter-rotating twin-screw extruders. Single screw extruders could be used as well, but should have a suitable screw design.

A typical twin-screw extruder has a UD ratio between 14 and 52, preferably between 30 and 50. The throughput strongly depends on the characteristics of the components extruded, for example organic and inorganic pigments, and the diameter of the extruder used, but, if an extruder with an diameter of 16 to 25 mm is used, the throughput is generally in the range of 0.5 kg/h to 30 kg/h, preferably 1 kg/h to 20 kg/h.

The temperature profile of the extruder depends on the resin and the pigments used as well as the layout of the extruder and the screw design. In general the temperature profile lies between 70° C., preferably 110° C. and the decomposition temperature of the resin, for example 140° C. for LAROPAL® A81.

Optionally, the extruder can be equipped with particular means for degassing and/or filtering the melt.

The extrudate is crushed, for example broken or cut, and optionally ground and/or sieved. The ground and sieved colorant granule compositions for spread coating have a maximum particle size below 500 μm, preferably the particle size of the colorant granule compositions lies within the range of 100 to 500 μm.

The invention relates also to an organic or inorganic, high molecular weight or low molecular weight material, especially a high molecular weight organic material comprising the colorant granules according to the invention in a tinctorially effective amount, generally in the range from 0.01 to 70% by weight, especially from 0.01 to 30% by weight, preferably from 0.01 to 10% by weight, based on the organic or inorganic material.

Hence, further embodiments of the instant invention relate to the use of the inventive colorant granules for the preparation of paint systems and coating materials, all of which are water-based. It is essential that the colorant granules create and retain a distinct phase effect on the substrate surface even after drying.

A conventional water-based paint system, which includes a clear coat composition, is provided with the colorant granules described above by addition in tinctorialy effective amounts. The colorant granules may be used singly or as a mixture of two or more uniquely colored forms. The means for application of this paint system are conventional in that the paint system is blended to ensure a relatively homogenous dispersion of pigment, if any, and colorant granules within the system. The blending is done in such a way as to avoid rupturing or otherwise breaking the colorant granules. The blended system is then preferably applied to a substrate, such as a wall, ceiling, paper, or any other surface onto which paint or coating can be used, using a brush, roller or sponge or any other means that provides adequate surface coverage and does not break the dispersed colorant granules. The colorant granules are then broken and spread while the paint film is wet or dry to produce a desired faux effect on the substrate. Optionally, the paint film having a faux effect is then coated with a clear coat to seal and protect the underlying film.

The following examples illustrate various embodiments of the invention, but the scope of the invention is not limited thereto.

### EXAMPLE 1

A mixture of 500 grams C.I. Pigment Red 254 and 500 grams of urea-aldehyde resin (Laropal A81 from BASF) is tumbled for 15 minutes. Afterwards the mixture is metered into a co-rotating twin-screw extruder with UD=14 (D=16 mm; r=250 rpm) with a throughput of 1.1 kg/h. The temperature profile is set to 130° C. The extrudate is then broken, ground and sieved to particles having a particle size below 500 μm. The concentration of C.I. Pigment Red 254 in the preparation is 65% by weight.

### EXAMPLE 2

10 grams of the pigment granules prepared in Example 1 are added to a water-borne latex paint system to produce a weight ratio of 2% based on the total weight of the paint system. The resulting paint system is applied via roller onto a number of substrates. When first applied, the only visible color is that of the base paint. Shear is then applied by sea sponge, brush or blade to the dry paint film on each of the number of substrates to burst the enclosed pigment granules and thereby expose the color therein. The resulting coating is then coated with a clear coat to create a lasting touchable finish.

### EXAMPLE 3

Example 2 is repeated with the exception that a combination of 5 grams of pigment granules prepared in Example 1 and 5 grams of a pigment granules prepared as in Example 1 using Pigment Blue 15 are added to a water-borne latex paint system.

We claim

1. A paint composition comprising a water-based paint system having an aqueous phase with colorant granules that do not dissolve in the aqueous phase.

2. A paint composition according to claim 1 wherein the colorant granule is a homogenous blend of a coloring agent and a urea-aldehyde resin and/or a urea-ketone resin.

3. A paint composition according to claim 2, wherein the coloring agent is an organic pigment selected from the group consisting of azo, azomethine, methine, anthraquinone, phthalocyanine, perinone, perylene, naphthol, benzimidazolone, diketopyrrolopyrrole, thioindigo, iminoisoindoline, dioxazine, iminoisoindolinone, quinacridone, flavanthrone, indanthrone, anthrapyrimidine and quinophthalone pigments, and mixtures or solid solutions thereof; especially an azo, dioxazine, diketopyrrolopyrrole, quinacridone, phthalocyanine, indanthrone, iminoisoindolinone pigment, and a mixture or solid solution thereof.

4. A paint composition according to claim 2, wherein the coloring agent is an inorganic pigment selected from the group consisting of carbon black, metal oxides, mixed metal oxides, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, nickel titanate and bismuth vanadate, and mixtures thereof.

5. A paint composition according to claim 1 wherein the colorant granules consists essentially of at least one pigment or dye and a urea-aldehyde resin, wherein the weight ratio of pigment to urea-aldehyde resin is in the range of 40:60 to 90:10.

6. A paint composition according to claim 5 wherein the coloring agent is a dye selected from the group consisting of reactive, solution, direct dyes and mixtures thereof.

7. A process for coating a substrate comprising applying a paint composition according to claim 1 onto said substrate.

8. A process for coating a substrate further comprising the step of subjecting the paint composition according to claim 1 to sufficient force to cause the colorant granules to release a colorant having a discernible color and to create a faux effect pattern on said substrate.

9. A process for preparing a paint composition comprising dispersing a colorant granule into a water-based paint system, wherein the colorant granule does not dissolve in the aqueous phase.

10. A paint composition comprising a water-based paint system having an aqueous phase containing a dispersed pigment and colorant granules, wherein the colorant granules do not dissolve in the aqueous phase.

11. A paint composition according to claim 10 wherein the colorant granule is a homogenous blend of a coloring agent and a urea-aldehyde resin and/or a urea-ketone resin.

12. A paint composition according to claim 11, wherein the coloring agent is an organic pigment selected from the group consisting of azo, azomethine, methine, anthraquinone, phthalocyanine, perinone, perylene, naphthol, benzimidazolone, diketopyrrolopyrrole, thioindigo, iminoisoindoline, dioxazine, iminoisoindolinone, quinacridone, flavanthrone, indanthrone, anthrapyrimidine and quinophthalone pigments, and mixtures or solid solutions thereof; especially an azo, dioxazine, diketopyrrolopyrrole, quinacridone, phthalocyanine, indanthrone, iminoisoindolinone pigment, and a mixture or solid solution thereof.

13. A paint composition according to claim 11, wherein the coloring agent is an effect pigment selected from the group consisting of multilayered interference structures.

14. A paint or coating composition according to claim 11, wherein the coloring agent is mica.

15. A paint composition according to claim 11, wherein the coloring agent is an inorganic pigment selected from the group consisting of carbon black, metal oxides, mixed metal oxides, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, nickel titanate and bismuth vanadate, and mixtures thereof.

16. A paint composition according to claim 10 wherein the colorant granules consist essentially of at least one pigment or dye and a urea-aldehyde resin, wherein the weight ratio of pigment to urea-aldehyde resin is in the range of 40:60 to 90:10.

17. A paint composition according to claim 16 wherein the coloring agent is a dye selected from the group consisting of reactive, solution, direct classes and mixtures thereof.

18. A process for coating a substrate comprising applying a paint composition according to claim 10 onto said substrate.

19. A process for coating a substrate further comprising the step of subjecting the paint composition according to claim 10 to sufficient force to cause the colorant granules to release a colorant with a discernible color and to create a faux effect pattern on said substrate.

20. A process according to claim 9 wherein the colorant granule is a homogenous blend of a coloring agent and a urea-aldehyde resin and/or a urea-ketone resin.

21. A process according to claim 9 wherein the colorant granules consist essentially of at least one pigment or dye and a urea-aldehyde resin, wherein the weight ratio of pigment to urea-aldehyde resin is in the range of 40:60 to 90:10.
